(19) United States
(12) Patent Application Publication
(10) Pub. No.: US 2013/0097119 A1
(43) Pub. Date: Apr. 18, 2013

(54) Method for Analyzing Performance Data for a Database

(71) Applicant: Lei Zeng, Irvine, CA (US)

(72) Inventor: Lei Zeng, Irvine, CA (US)

(21) Appl. No.: 13/275,114

(22) Filed: Oct. 17, 2011

(51) Int. Cl. G06F 17/30; G06F 7/00

(52) U.S. Cl. 707/640; 707/754; 707/E17.044; 707/E17.014

(57) ABSTRACT

Computer implemented software uses multi-dimension analysis to identify performance issues, locate the root cause(s) of performance problems, and may also serve other purposes such as workload management, capacity planning In especially preferred embodiments, there can be three, four or even more dimensions being analyzed. Useful dimensions are contemplated to include database call, execution path, process status, target, and application that generates database calls. In the specific world of Oracle databases, the database call is a SQL statement, the execute path is a SQL plan, the process status is an event, the target is a database object or a database file, and the application that generates database calls is a session, or user, or service, or module, or machine. Primary and secondary attributes of dimensions can be used to facilitate analysis. GUIs can advantageously present data in matrix format that facilitates dimension picking.

### FIELD OF THE INVENTION

The field of the invention is database performance analysis.

### BACKGROUND

With the release of Oracle™ 10g, AWR (Automatic Workload Repository) was introduced as the framework that takes frequent snapshots of database performance, and writes at least part of that data to persistent storage (a series of DBA_HIST_*tables).

Oracle databases have two basic categories of performance data, (1) cumulative statistics and metrics and (2) sampled data. Good examples of cumulative statistics are available in table DBA_HIST_SYSSTAT. Cumulative statistics relate to information summed up at database instance level. The value of such statistics keep growing over time, and are generally only reset when the database instance restarts. Database analysts often calculate delta values of such statistics between two points in time. Metrics are derived from cumulative statistics by calculating the rate of their changes against a time unit, or other units like transaction, database call etc. The term ‘AWR data’ generally refers to this category of performance data.

Good examples of sampled data are available in table DBA_HIST_ACTIVE_SESS_HISTORY. Those data relate to session level information, and are generated by Oracle's ASH (Active Session History) framework through sampling active sessions of a database. Database analysts check such sampled data according to certain significance thresholds by measuring their percentage within each sampling set, and their frequency across multiple sampling sets. The term ‘ASH data’ refers to this category of performance data.

Oracle provides two separate tools to analyze database performance data: an AWR report and an ASH report. Those reports are not completely adequate. (1) Both reports analyze data as a one-time aggregate. In order to analyze the data over a series of time intervals, multiple reports have to be generated. (2) Although Oracle points out some dimensions for ASH data, those are not clearly explained and consistent across two different types of reports. (3) The reports lack flexibility, particularly with respect to (i) performing multiple-dimension analysis to examine the correlation relationship among dimensions, and (ii) searching data in dimensions based on user-defined filtering criteria to facilitate identifying particularly interested data.

Oracle uses the term “dimensions” to categorize data. Examples are customers, products, and time. In the world of database performance, Oracle dimensions include Session, SQL, Wait Event, Blocking Session, Object and Application as categories of data that that contribute to database performance.

This and other information relevant to the present patent application are disclosed in a recent article co-authored by the present inventor, S. Selvaganesan and L. Zeng, CPU Spikes and Top CPU SQL, Select Journal, Vol. 18, No. 2, p. 5 (Second Quarter, 2011). This article, and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

There are third-party providers of performance analysis tools, but such tools have similar inadequacies to Oracle's AWR report and an ASH reports. For example, none of the following use any sort of multi-dimension analysis.

Ion for Oracle™ http://www.ion-dba.com/ION features.htm

spViewer™ (http://spviewer.com/)

DB Optimizer http://www.embarcadero.com/products/db-optimizer-xe

Foglight for Performance Analysis for Oracle http://www.quest.com/foglight-performance-analysis-for-oracle/

Of course, these same concepts can be applied to other sophisticated databases, including for example, Microsoft™ SQL Server™, MySQL™, and Progress SQL™, and even some non-SQL databases.

Thus, there is still a need for software, systems and methods in which a multi-dimension analysis is employed to identify performance issues, locate the root cause(s) of database performance problems, and may also serve other purposes such as workload management, capacity planning, etc.

### SUMMARY OF THE INVENTION

The inventive subject matter provides apparatus, systems and methods in which computer implemented software uses multi-dimension analysis to identify performance issues, locate the root cause(s) of performance problems, and may also serve other purposes such as workload management, capacity planning, etc.

In preferred embodiments, the software assists a human user to analyze performance of a database for which there exists first and second dimensions that contribute to the performance, the method comprising: providing a first interface to the user that allows the user to designate the first dimension from at least one of database call, execution path, process status, target, and application that generates database calls; providing a second interface to the user that allows the user to designate a first filtering criterion; providing a third interface to the user that allows the user to designate a time series; and producing a performance report using as criteria the first dimension, the filtering criterion, and the time series.

In especially preferred embodiments, there can be three, four or even more dimensions being analyzed. Useful dimensions are contemplated to include database call, execution path, process status, target, application that generates database calls. In the specific world of Oracle databases, the database call is a SQL statement, the execute path is a SQL plan, the process status is an event, the target is a database object or a database file, and the application that generates database calls is a session, or user, or service, or module, or machine.

It is further contemplated that dimensions could have primary and secondary attributes. For example, a dimension of SQL can have SQL ID as a primary attribute and SQL OPCode as a secondary attribute. The distinction is that during a multi-dimension analysis, a primary attribute is generally required, and a secondary attribute is generally optional.

In one aspect of especially preferred embodiments, all of the first, second and third interfaces are displayed on a single graphical user interface. That interface can advantageously include a matrix having a first set of cells that summarize occurrences in performance data resulting from application of the first and second dimensions to the database. A more complex matrix could include a second set of cells that summarize occurrences in the performance data resulting from application of the first dimension and a third dimension. The matrices facilitate dimension picking, as described below.

Contemplated GUIs can also advantageously provide the user with a list of dimensions available for analysis, and more preferably provide the user with an expansion capability with which the user can visualize combinations of the dimensions.

Contemplated GUIs can also provide auto-completion of one or more fields, including for example filtering criterion fields.

Although one could use the inventive software, methods and systems on a live database, it is considered preferable to make copy of at least a portion of the performance data, store the copy external to the database, and then operate against the copy. Where the software is operated against a live database, it is advantageous to use a read-only login.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of two connection models.

FIG. 2 is a chart summarizing some of the dimensions contemplated herein for a multi-dimension analysis.

FIG. 3 is a detailed listing of selected dimensions of ASH data.

FIG. 4 is a detailed listing of selected dimensions of AWR data.

FIG. 5 is a screen shot of a sample graphical user interface showing a dimension tree structure.

FIG. 6 is a screen shot of a sample graphical user interface that produces a report starting at the middle of the screen, with respect to a single dimension of SQL. The GUI also shows data entry fields for time limits and other filtering criteria, buttons for selecting additional dimensions, and report data in a matrix format to facilitate dimension picking.

FIG. 7 is a screen shot of the sample graphical user interface of FIG. 6, but also showing the SQL statement being used to create the report.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

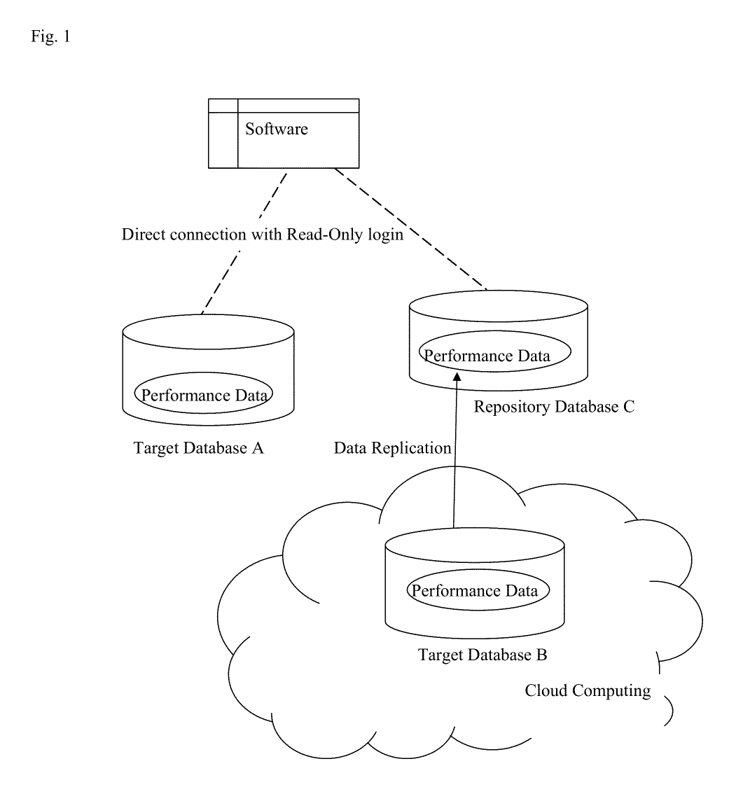

In FIG. 1, a software program either makes direct connections to the target Oracle to be analyzed, or to another Oracle database which holds the performance data of the target Oracle database to be analyzed. The connection preferably requires only a read-only login to the database. Where the target is an Oracle database, the software can advantageously send queries to run on the database via Oracle JDBC driver and all queries are ‘SELECT’ statements. No ‘write’ permission is needed.

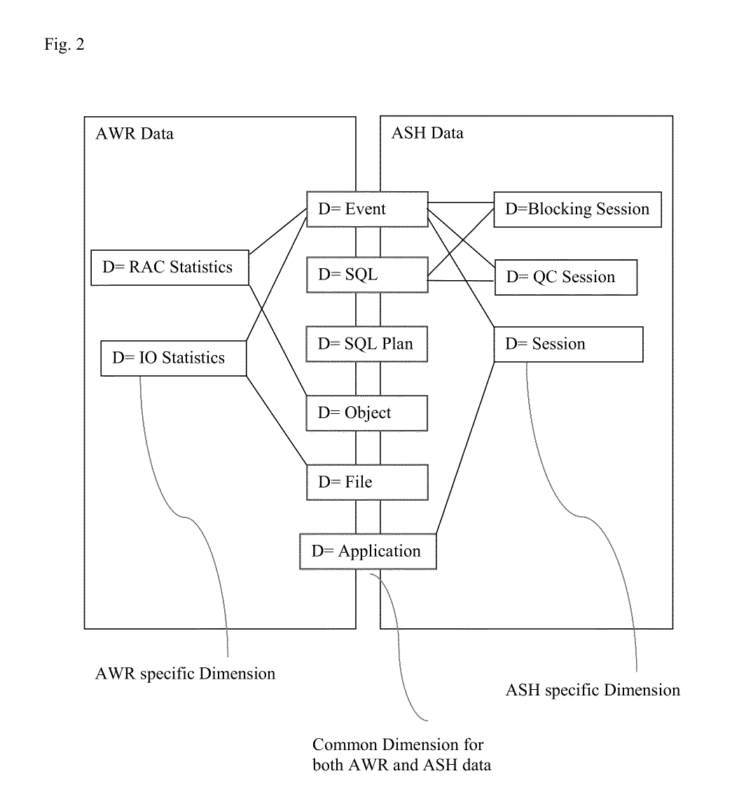

In FIG. 2 contemplated AWR-related dimensions are listed on the left, contemplated ASH-related dimensions are listed on the right, and common dimensions are listed in the middle. The common dimensions include, but are not limited to, event, SQL, SQL plan, object, file, and application. The AWR specific dimensions include IO statistics, RAC statistics etc. ASH specific dimensions include session, blocking session, QC session, etc.

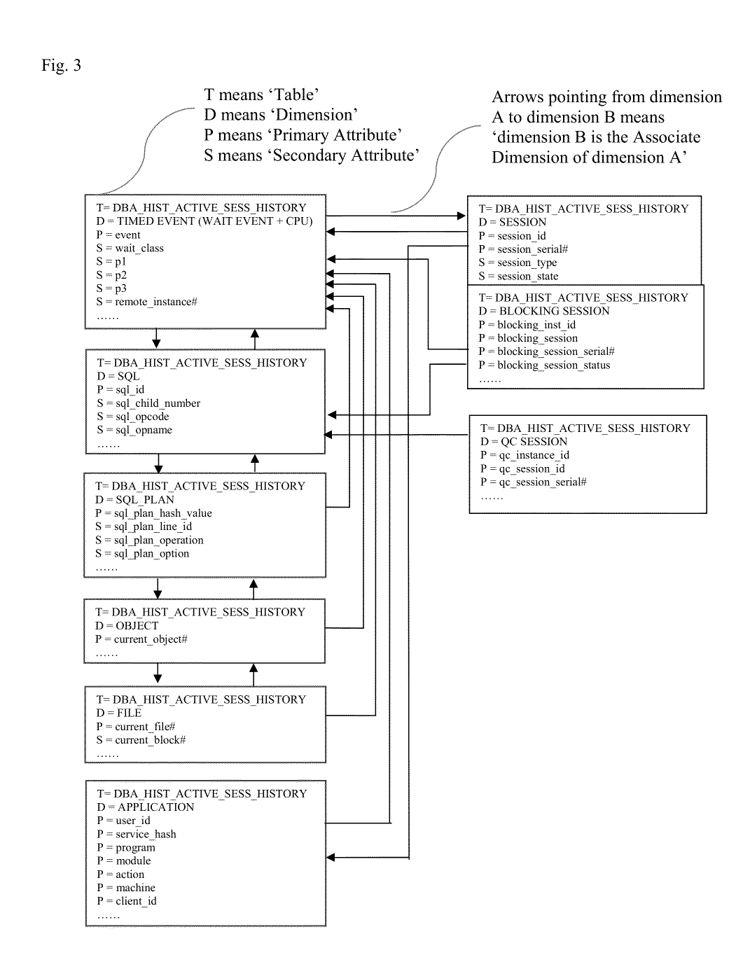

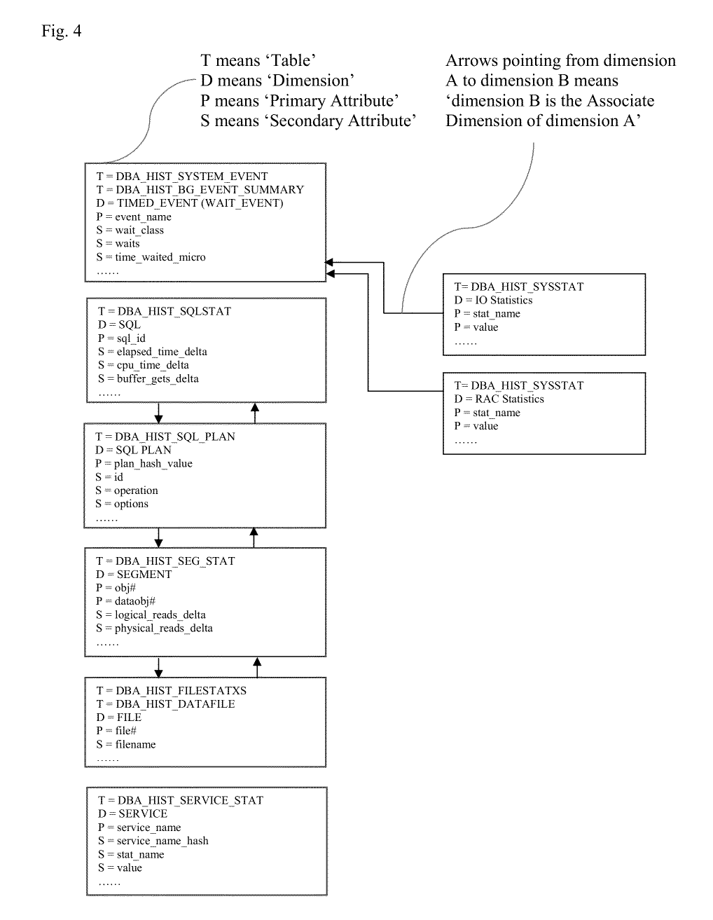

In FIGS. 3 and 4 each dimension is represented by primary attributes and secondary attributes. Primary attributes are those table columns that can uniquely identify a dimension. Secondary attributes have functional dependency on primary attributes. If a dimension is included into analysis, primary attributes generally must be included, while secondary attributes are generally optional. For each dimension, one or multiple other dimensions are identified as its associated dimensions in order to allow them to be analyzed together to reveal their correlation relationship.

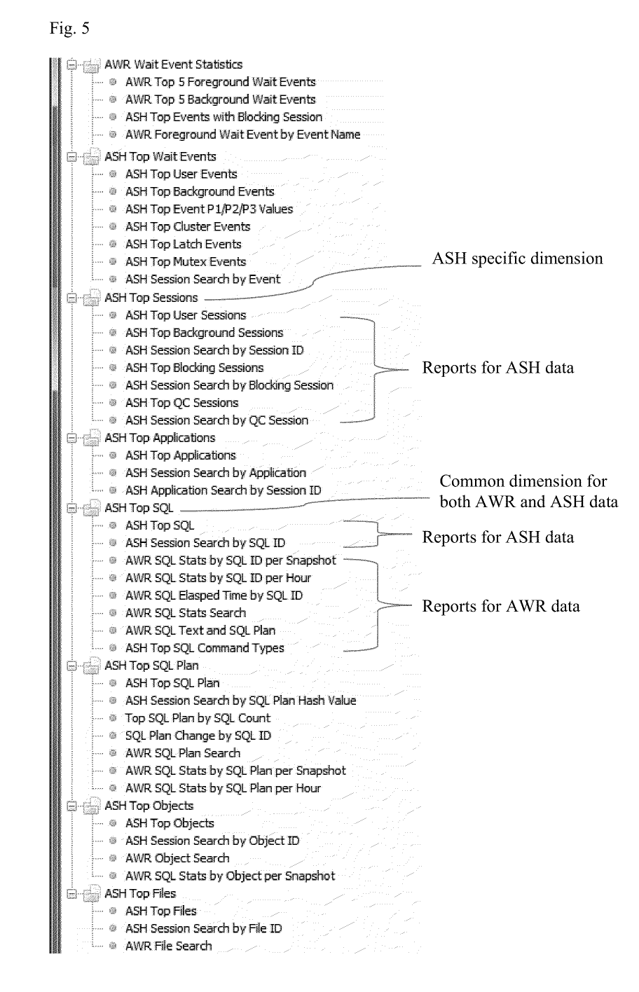

FIG. 5 depicts a tree structure in which the branches are the dimensions, and the leaves are individual reports. Individual reports for a common dimension would generally include both AWR and ASH data. Individual reports for an AWR or ASH specific dimension would include either AWR data or ASH data.

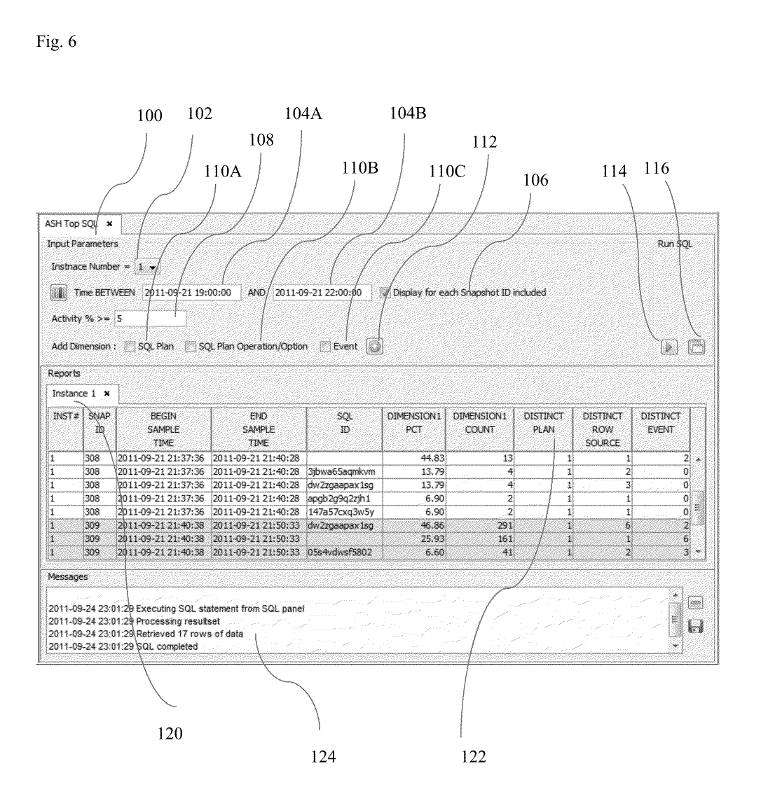

In FIG. 6 a sample graphical user interface 100 includes the following fields: instance number 102, beginning and ending timestamps 104A, 104B, time series option 106, activity percentage limit 108, add dimensions button 110A, 110B and 110C, button 112 to add more filtering criteria, run SQL statement button 114, show SQL statement button 116. Also shown is a sample report 120, matrix 122 to facilitate dimension picking, and a run time message panel 124.

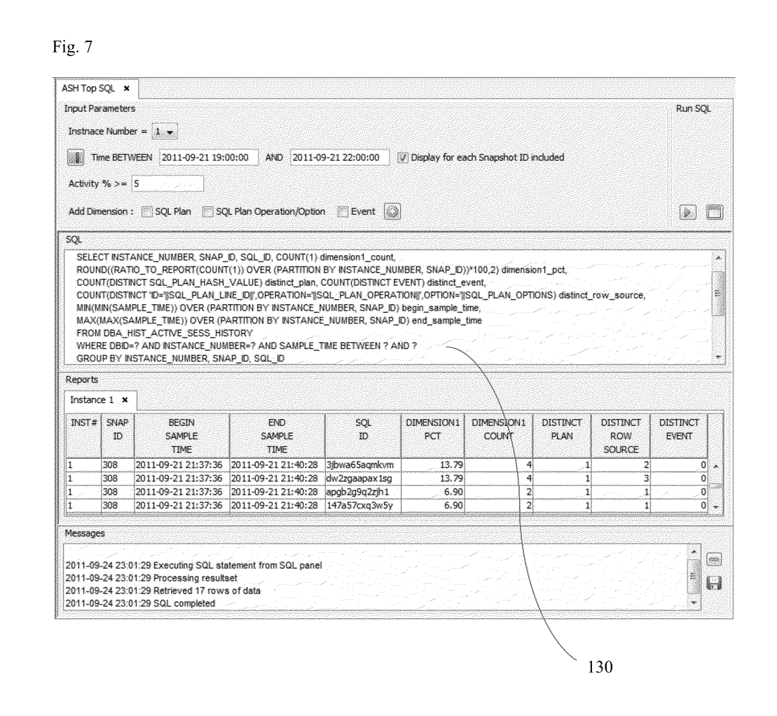

FIG. 7 has the same features as FIG. 6, but also includes a window 130 showing the SQL statement being used to create the sample report.

It should be noted that while the following description is drawn to a computer/server based work package processing system, various alternative configurations are also deemed suitable and may employ various computing devices including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of assisting a human user to analyze performance of a database for which there exists first and second dimensions that contribute to the performance, the method comprising:
providing a first interface to the user that allows the user to designate the first dimension from at least one of database call, execution path, process status, target, and application that generates database calls;
providing a second interface to the user that allows the user to designate a first filtering criterion;
providing a third interface to the user that allows the user to designate a time series; and
producing a performance report using as criteria the first dimension, the filtering criterion, and the time series.

2. The method of claim 1 wherein all of the first, second and third interfaces are displayed on a single graphical user interface.

3. The method of claim 1 wherein the database call is a SQL statement, the execute path is a SQL plan, the process status is an event, the target is a database object or a database file, and the application that generates database calls is a session, or user, or service, or module, or machine.

4. The method of claim 1 further comprising providing a fourth interface to the user that allows the user to designate the second dimension from one of database call, execution path, process status, target, application that generates database calls.

5. The method of claim 4 wherein the performance report depicts a matrix having a first set of cells that summarize occurrences in performance data resulting from application of the first and second dimensions to the database.

6. The method of claim 5 wherein the matrix has a second set of cells that summarize occurrences in the performance data resulting from application of the first dimension and a third dimension.

7. The method of claim 1 wherein the database includes performance data, and further comprising making a copy of at least a portion of the performance data, storing the copy external to the database, and the step of producing the performance report includes operating against the copy.

8. The method of claim 1 further comprising providing the user with a list of available dimensions, including the first and second dimensions, and providing the user with an expansion capability with which the user can visualize combinations of the available dimensions.

9. The method of claim 1 wherein the first dimension has primary and secondary attributes, and further comprising producing a performance report using a combination of primary and secondary attributes.

10. The method of claim 1 further comprising auto-completion of at least one filtering criterion field.

11. The method of claim 1 wherein the step of producing a performance report is accomplished using a read-only login.
